(19) United States
(12) Patent Application Publication
(10) Pub. No.: US 2022/0183240 A1
(43) Pub. Date: Jun. 16, 2022

(54) SYMBIOTIC AGRICULTURAL SYSTEM

(71) Applicants: John Clarence HOLLIDAY, Carson City, NV (US); Howard Louis ROGERS, Minneapolis, MN (US); Greggory Scott HAUGEN, Orono, MN (US); Laurence Alexis ANDERSON, Apple Valley, MN (US); Louis L. OCHOCKI, Blaine, MN (US); Michael James Macaluso, Minneapolis, MN (US)

(72) Inventors: John Clarence HOLLIDAY, Carson City, NV (US); Howard Louis ROGERS, Minneapolis, MN (US); Greggory Scott HAUGEN, Orono, MN (US); Laurence Alexis ANDERSON, Apple Valley, MN (US); Louis L. OCHOCKI, Blaine, MN (US); Michael James Macaluso, Minneapolis, MN (US)

(21) Appl. No.: 17/644,252

(22) Filed: Dec. 14, 2021

Related U.S. Application Data
(60) Provisional application No. 63/125,647, filed on Dec. 15, 2020.

(51) Int. Cl. A01G 18/69; A01G 7/02

(52) U.S. Cl. CPC A01G 18/69; A01G 7/02

(57) ABSTRACT

A symbiotic agricultural system includes a fungi growing environment and a plant growing environment. The symbiotic agricultural system includes a control system that controls airflow from the fungi growing environment to the plant growing environment based on a carbon dioxide level in the plant growing environment.

### CROSS-REFERENCE TO RELATED APPLICATIONS

The present application is based on and claims the benefit of U.S. Provisional Patent Application Ser. No. 63/125,647 filed Dec. 15, 2020, the contents of which is hereby incorporated by reference in its entirety.

### SUMMARY

A symbiotic agricultural system includes a fungi growing environment and a plant growing environment. The symbiotic agricultural system includes a control system that controls airflow from the fungi growing environment to the plant growing environment based on a carbon dioxide level in the plant growing environment.

This summary is provided to introduce a selection of concepts in a simplified form that are further described below in the Detailed Description. This summary is not intended to identify key features or essential features of the claimed subject matter, is not intended to describe each disclosed embodiment or every implementation of the claimed subject matter, and is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a block diagram showing an example symbiotic farming environment.

FIG. 2 is a flow diagram showing an example symbiotic agricultural operation.

FIG. 3 is a block diagram showing one example of a computing environment.

FIG. 4 is a diagram showing an example symbiotic agricultural environment.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

Indoor vertical farms are systems that grow agricultural products in an indoor closed environment. These systems sometimes require supplements, such as carbon dioxide, to improve the growth rate or quality of a plant. Currently, carbon dioxide is generated from other processes that are inefficient or not environmentally friendly. This disclosure describes a more efficient system of agricultural symbiosis to generate supplements for agricultural operations.

All plants produce oxygen in the process of photosynthesis. An important requirement in this process is for the plants to ingest carbon dioxide gas. The level of carbon dioxide in the air is impacted primarily, from the use of fossil fuels. A natural source of carbon dioxide can be generated by fungi. As plants consume carbon dioxide and generate oxygen and water, fungi are the reverse. Fungi consume oxygen and water and create carbon dioxide. A purpose of fungi in nature is as the digester of the forest floor. Fungi consumes dead and dying trees, helping them to compost, while producing carbon dioxide as a byproduct of its growth cycle.

The symbiotic relationship between fungi and plants, can help increase the yield of the plant items, grown and cultivated in the symbiotic farm, by utilizing technology to control the levels and flow of carbon dioxide from the fungi growing operation(s) to the plant growing operation(s). This process is accomplished using control systems that monitor carbon dioxide levels in the fungi operation(s) and/or plant growing operation(s). In some examples the control systems, also control the moisture content, temperature control, and lighting (including the specific color band best suited for each product) and other aspects of the environments.

One example type of fungi includes mushrooms. In some examples, the mushrooms have commercial value as edible products or other commercially useful products.

Mushroom operations can use “clean room” technology in the design of the growing rooms. In these clean rooms the bacteria and other airborne contaminants are removed to prevent interference with the fragile process of mushroom cultivation. In some examples, the air is filtered by HEPA filtration systems, while maintaining positive room air pressures which also helps keep airborne bacteria and other unwanted contaminates out of the process. Functions, such as inoculating mushroom columns, can be conducted within a specially designed inoculation room and spawn development in a specialized laboratory.

In the first stage of a mushroom operation, at a specific time in the culturing process, high levels of carbon dioxide gas are produced in the mushroom growing rooms. The carbon dioxide levels can be controlled in the fungi environment for optimal mushroom cultivation, while venting and controlling large amounts of excess carbon dioxide into the plant growing rooms. Increasing the carbon dioxide saturation levels in the plant growing rooms to a specific target level for each specific plant, will shorten those plants growing period while dramatically increasing yields.

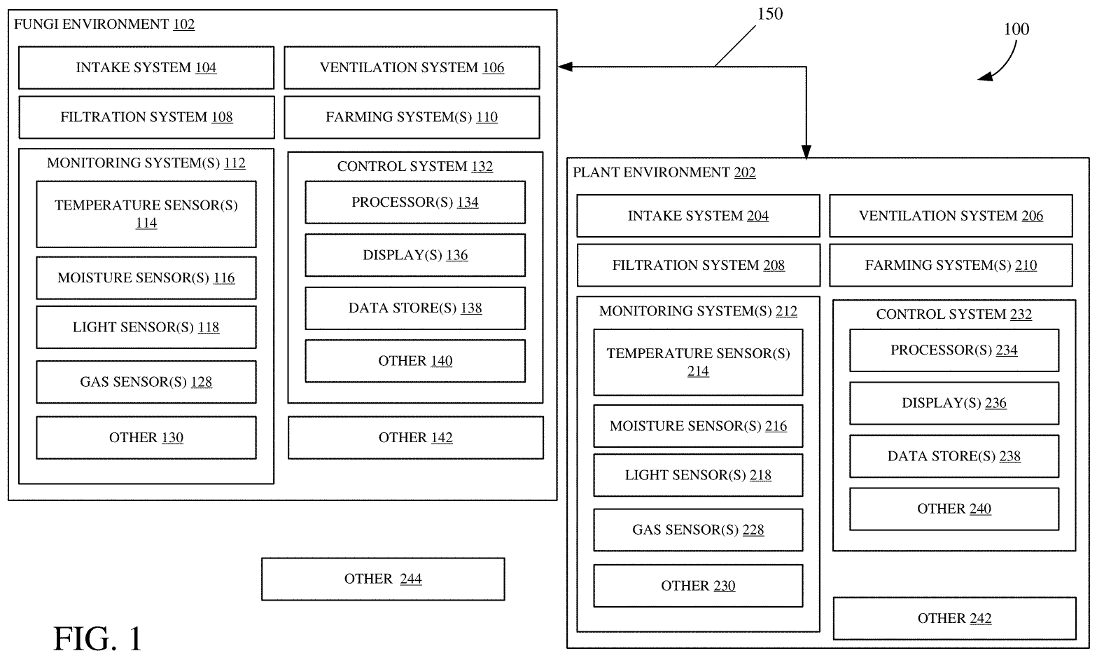

FIG. 1 is a block diagram showing an example symbiotic farming environment 100. Environment 100 includes fungi environment 102 and plant environment 202. Fungi environment 102 and plant environment 202, in some examples, are indoor agricultural environments. Each environment can have their environment individually controlled. In some examples, the environments are closed environments that only receive or discharge air, water, or other items through controlled channels.

Fungi environment 102 includes components that facilitate the growing of fungi products. In some examples, the fungi products are edible. In some examples, the fungi products are chosen based on their efficiency at generating carbon dioxide. In some examples, the fungi products are chosen based on a balance between commercial value and efficiency at generating carbon dioxide. Some example species/hybrids include shiitake and oyster mushrooms which produce carbon dioxide rapidly (sometimes half of their weight) or maitake and king stropharia which produce carbon dioxide over a longer period of time. Fungi environment 102 includes intake system 104, ventilation system 106, filtration system 108, farming systems 110, monitoring systems 112, control system 132 and can include other items as well as indicated by block 142. Intake system 104 is used to intake air into fungi environment 102. Intake system 104 can receive air from plant environment 202 or other items 244.

Ventilation system 106 is used to vent air from fungi environment 102. For example, when the air in fungi environment 102 reaches a certain percentage of carbon dioxide, the air can be vented into plant environment 202.

Filtration system 108 is used to filter the air in fungi environment 102. Filtration system 108 can remove contaminants from the air. In some examples, filtration system 108 is coupled to intake system 104. In some examples, filtration system 108 includes HEPA filters. In some examples, filtration system 108 removes specific chemicals and elements from the water, including arsenic and heavy metals from water.

Farming systems 110 include the systems required to inoculate and grow the fungi. Some examples of farming systems 110 include irrigation, growing substrates, inoculation systems, etc.

Monitoring systems 112 include systems that monitor conditions of fungi environment 102. Monitoring systems 112, as shown, include temperature sensors 114, moisture sensors 116, light sensors 118, gas sensors 128 and can include other items as well as indicated by block 130. Temperature sensors 114 monitor the temperature of fungi environment 102. Moisture sensors 116 monitor the moisture of fungi environment 102. In some examples, moisture sensors 116 monitor the air moisture. In some examples, moisture sensors 116 monitor the growing substrate moisture. In some examples, moisture sensors 116 monitor the fungi moisture. Light sensor 118 monitor the light at one or more locations in fungi environment 102. Gas sensors 128 monitor the gas in one or more locations in fungi environment 102. In some examples, gas sensors 128 can sense the amount of carbon dioxide in fungi environment 102. In some examples, gas sensors 128 can sense the amount of oxygen in fungi environment 102. In some examples, gas sensors 128 can sense other gas properties as well, such as airborne contaminants. Monitoring systems 112 can include other sensors as well that sense other characteristics or conditions of fungi environment 102.

Control system 132 includes items that control various aspects of fungi environment 102. Control system 132 includes processors 134, displays 136, data stores 138 and can include other items as indicated by block 140. Control system 132 can receive signals from monitoring system 112 and control items of fungi environment 102. For instance, control system 132 can receive signals from monitoring system 112 indicative of carbon dioxide levels in fungi environment 102 and when the levels reach a certain level the carbon dioxide is captured. Once captured, the carbon dioxide can be vented through conduit 150 to plant environment 202.

Plant environment 202 includes intake system 204, ventilation system 206, filtration system 208, farming systems 210, monitoring systems 212, control system 232 and can include other items as well as indicated by block 242. Intake system 204 is used to intake air into plant environment 202. Intake system 204 can receive air from plant environment 202 or other items 244.

Ventilation system 206 is used to vent air from plant environment 202. For example, when the air in plant environment 202 reaches a certain percentage of oxygen, the air can be vented into fungi environment 102.

Filtration system 208 is used to filter the air in plant environment 202. Filtration system 208 can remove contaminants from the air. In some examples, filtration system 208 is coupled to intake system 204. In some examples, filtration system 208 includes HEPA filters. In some examples, filtration system 208 removes specific chemicals and elements from the water, including arsenic and heavy metals from water.

Farming systems 210 include the systems required to inoculate and grow the plants. Some examples of farming systems 210 include irrigation, growing substrates, lighting systems, etc. These lighting systems can be designed to illuminate specific color bands of the color spectrum. The lighting systems designed specifically for the targeted crops. For example, to grow tomatoes to their best quality, most effectively, only 1 color band of the 55 red colors in the spectrum, produce the best results. Phillip's has developed LED lighting for commercial greenhouse.

Monitoring systems 212 include systems that monitor conditions of plant environment 202. Monitoring systems 212, as shown, include temperature sensors 214, moisture sensors 216, light sensors 218, gas sensors 228 and can include other items as well as indicated by block 230. Temperature sensors 214 monitor the temperature of plant environment 202. Moisture sensors 216 monitor the moisture of plant environment 202. In some examples, moisture sensors 216 monitor the air moisture. In some examples, moisture sensors 216 monitor the growing substrate moisture. In some examples, moisture sensors 216 monitor the plant moisture. Light sensor 218 monitor the light at one or more locations in plant environment 202. Gas sensors 228 monitor the gas in one or more locations in plant environment 202. In some examples, gas sensors 228 can sense the amount of carbon dioxide in plant environment 202. In some examples, gas sensors 228 can sense the amount of oxygen in plant environment 202. In some examples, gas sensors 228 can sense other gas properties as well, such as airborne contaminants. Monitoring systems 212 can include other sensors as well that sense other characteristics or conditions of plant environment 202.

Control system 232 includes items that control various aspects of plant environment 202. Control system 232 includes processors 234, displays 236, data stores 238 and can include other items as indicated by block 240. Control system 232 can receive signals from monitoring system 212 and control items of plant environment 202. For instance, control system 232 can receive signals from monitoring system 212 indicative of carbon dioxide levels in plant environment 202 and when the levels reach a certain level the carbon dioxide is captured. Once captured, the oxygen can be vented through conduit 150 to fungi environment 202.

In some examples, control system 132 and 232 are the same control system. As shown, the components are shown within the environments 102 and 202. In other examples, one or more of the components are located at different locations than illustratively shown. For instance, control systems 132 and/or 232 can be located remotely from the environments (e.g., in the cloud or in a separate or non-agricultural environment).

In some examples, control system 132 and 232 include additional controls. For example, the control of humidity and the watering requirements of plants and fungi are also the responsibility of control systems 132 and 232.

Conduit 150 is shown as connecting environment 102 to environment 202. In some examples, carbon dioxide is captured from environment 102 in a vessel and discharged into environment 202 at a later time, conduit 150 explicitly covers this and other forms of transfers between environment 102 and 202.

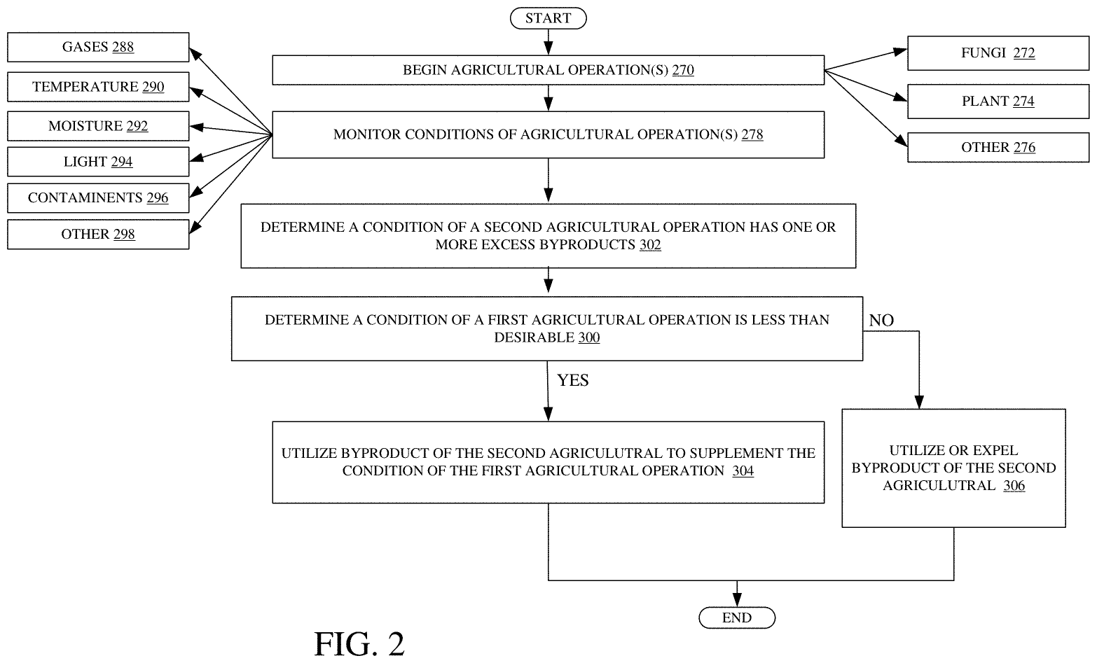

FIG. 2 is a flow diagram showing an example symbiotic agricultural operation. Operation 268 begins at block 270. The agricultural operation can include a fungi growing operation as indicated by block 272. The agricultural operation can include a plant growing operation as indicated by block 274. The agricultural operation can include other items as well as indicated by block 276. For example, other agricultural operations can include raising livestock. In some examples, livestock can include aquaculture.

Operation 268 proceeds at block 278 where conditions of the agricultural operations are monitored. As indicated by block 288, the gases in one or more location of the agricultural operation can be monitored. As indicated by block 290, the temperature one or more locations in the agricultural operation can be monitored. As indicated by block 292, the moisture of one or more locations can be monitored. As indicated by block 294, the light at one or more locations in the agricultural operation can be monitored. As indicated by block 296, the contaminants at one or more location in the agricultural operation can be monitored. Of course, other conditions may be monitored as well, as indicated by block 298.

Operation 268 proceeds at block 302. At block 302 it is determined if a condition of a second agricultural operation has one or more excess byproducts. For instance, a plant agricultural operation may have excess oxygen. Or for instance, a fungi agricultural operation may have excess carbon dioxide.

Operation 268 proceeds at block 300. At block 300 it is determined if a condition of a first agricultural operation is less than desirable. For instance, a plant agricultural operation may have lower than desirable carbon dioxide. Or for instance, a fungi agricultural operation may have higher than desirable carbon dioxide. Operation 268 proceeds at block 304 if it is determined that a condition in the first agricultural operation is less than desirable. Operation 268 proceeds at block 306 if it is determined that a condition in the first agricultural operation is not less than desirable.

At block 304 the byproduct from one agricultural operation is used to supplement another agricultural operation. For example, the carbon dioxide from the fungi operation is used as a supplement to the plant operation. Plants can receive too high a dose of carbon dioxide that will harm the corresponding plants, so it can be controlled that the plants receive the correct levels of carbon dioxide (when the levels get too high, operation 268 can proceed at block 306). When carbon dioxide in the fungi and/or fungi operation reaches the targeted level of gas, as determined by the species of plants in the system, gas is vented to the plants. Or for example, the oxygen from the plant operation is used as a supplement to the fungi operation.

At block 306 the byproduct from one agricultural operation can be exhausted or stored. For example, the carbon dioxide from a fungi environment can be exhausted to atmosphere. Or for example, the carbon dioxide from a fungi environment can be stored.

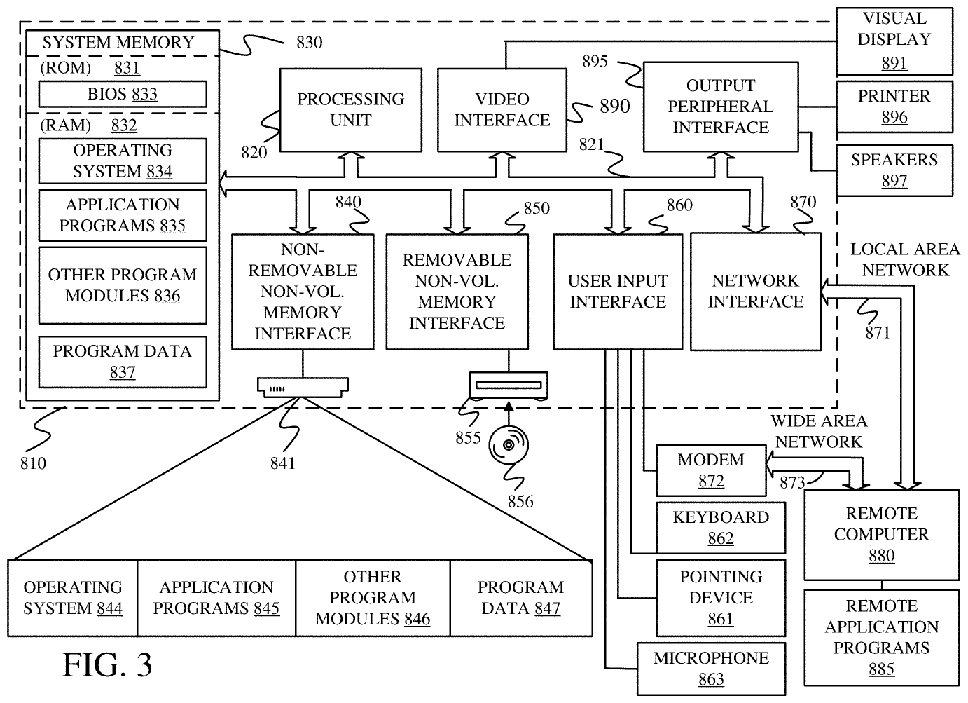

FIG. 3 is one example of a computing environment in which elements of FIG. 1 can be deployed. With reference to FIG. 3, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIGS. 1, 2 and 4 can be deployed in corresponding portions of FIG. 3.

Computer 810 typically includes a variety of computer readable media. Computer readable media may be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory or both such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data or program modules or both that are immediately accessible to and/or presently being operated on by processing unit 820. By way of example, and not limitation, FIG. 3 illustrates operating system 834, application programs 835, other program modules 836, and program data 837.

The computer 810 may also include other removable/non-removable volatile/nonvolatile computer storage media. By way of example only, FIG. 3 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 3, provide storage of computer readable instructions, data structures, program modules and other data for the computer 810. In FIG. 3, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 3 illustrates, for example, that remote application programs 885 can reside on remote computer 880.

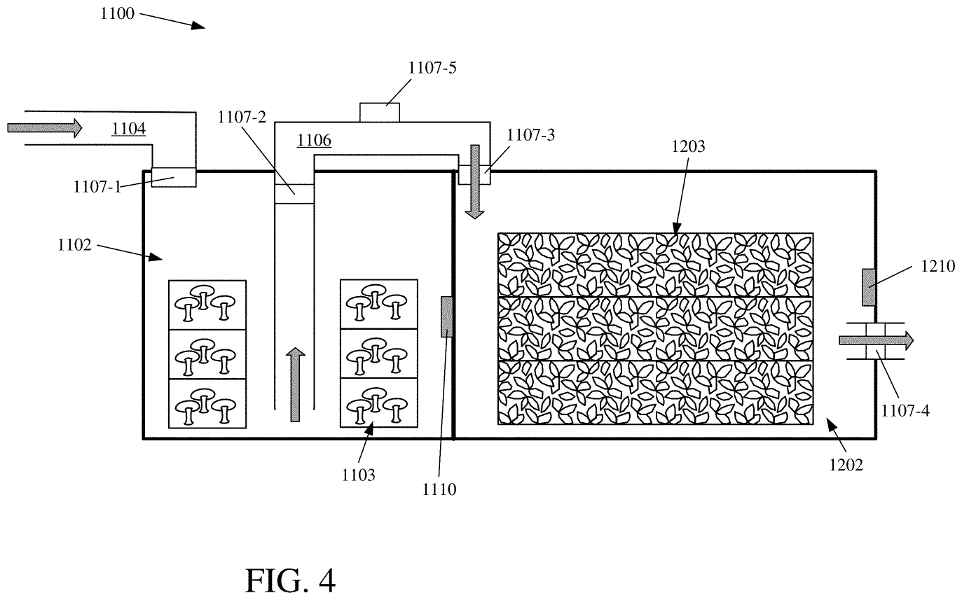

FIG. 4 is a diagram showing an example symbiotic agricultural system 1100. Agricultural system 1100 as shown includes mushroom growing environment 1102 and plant growing environment 1202. In some examples, system 1100 can include one or more components of FIG. 1 or vice versa.

Control systems 1110 and 1210 can include sensor(s)/monitoring system(s) and controller(s). Control systems 1110 and 1210 monitor conditions and control systems to keep environments 1102 and 1202 in conditions that allow for growth of mushrooms 1103 and plants 1203. For example, control system 1210 in plant growing environment 1202 can determine carbon dioxide is low and calls for additional carbon dioxide, control system 1210 also senses the room temperature is approaching the minimum room temperature as set in environment 1202, and also is sensing the air is too dry. Based on the desired setting programmed into the system, control system 1210 will open vent 1107-3 from the mushroom growing environment(s) 1102 simultaneously as vent 1107-2 opens. Positive pressure will transfer the carbon dioxide into plant growing environment 1202, until a threshold high carbon dioxide level is reached, at which point those vents 1107-2 and 1107-3 will close. Regarding the room temperature, control system 1210 reads the low temperature point, vents open and warm, filtered air will be transferred into the plant grow environment 1202 until the temperature reached a threshold high temperature level, at which point that function will cease. Similarly, moisture and watering conditions can be controlled in corresponding ways as well. In some examples, control systems 1110 and 1210 are the same system. In some examples, control systems 1110 and 1210 include components described in FIG. 1, such as monitoring systems 116 and 212 and control systems 132 and 232.

Mushrooms 1103 consume oxygen and generate carbon dioxide throughout their entire growth cycle. The rate at which the mushrooms 1103 generate carbon dioxide varies depending on the growth rate, where in the growth cycle to mushroom is, the species of mushroom and the available nutrients in the growing medium.

The concentration of carbon dioxide levels in the mushroom growing environment 1102 can be controlled by control system 1110 to increase the growth and yield of mushrooms 1103. In order to maintain desirable levels of different gases, gas monitoring is done on the mushroom growing environment 1102 by control system 1110. When the carbon dioxide level rises to a threshold level, sensed by control system 1110, mushroom growing environment 1102 can be pressurized above atmospheric pressure (or some other pressure external to mushroom growing environment 1102). In some examples, this pressure differential is between one and ten inches of water pressure above ambient atmospheric pressure and more specifically, between approximately six to seven inches water pressure above ambient. In some examples, mushroom growing environment 1102 is pressurized by blowers which bring air into the mushroom growing environment 1102 through conduit 1104. In some examples, blowers include fans. In some examples, blowers include impellers. In some examples, a pressurized tank or other vessel is used to pressurize mushroom growing environment 1102. In some examples, rather than pressurizing mushroom growing environment 1102, a destination (e.g., plant growing environment 1202 or another external location) can have its pressure reduced, when referring to pressurizing mushroom growing environment 1102, this opposite configuration is also expressly contemplated.

The pressurized air in environment 1102 displaces the carbon dioxide in environment 1102, carbon dioxide (and air) out of environment 1102 through conduit 1106 connecting the mushroom growing room 1102 and the plant growing environment 1202. The pressurization of and discharge of air from, mushroom growing environment 1202 continues until the carbon dioxide level drops to a threshold level. Once the carbon dioxide level in the mushroom environment 1102 drops to the threshold level, control system 1110 controls the pressurization to stop. The carbon dioxide and air thus introduced into the growing room 1102 is exhausted through conduit 1106, which connects the mushroom growing environment(s) 1102 to the plant growing environment(s) 1202. As the mushrooms 1103 consume oxygen and generate carbon dioxide, the carbon dioxide level rises, repeating the aforementioned cycle over and over, maintaining the carbon dioxide in the mushroom growing environment 1102 between optimum preset upper and lower limits.

There is a vent 1107-5 located in the duct or pipe between the mushroom growing environment 1102 and the plant growing environment 1202. Vent 1107-5 is normally in the open position, allowing free discharge of the mushroom carbon dioxide and other air to exterior to the environments 1102 and 1202. The more that vent 1107-5 is closed and the more vents 1107-2 and 1107-3 are open, the more air that is sent from environment 1102 to environment 1202 rather than being exhausted externally to the environments 1102, 1202.

The adjacent plant growing environment 1202 (e.g., a greenhouse, vertical growing system, etc.) contains plants 1203. As plants 1203 grow they consume carbon dioxide and exhaust oxygen. Since plants 1203 consume carbon dioxide, by elevating the levels of carbon dioxide in the plant environment 1202, higher metabolic rates are generated in plants 1203, accelerating the growth rate and health of plants 1203, thereby resulting in higher yields and shorter cultivation time of plants 1203. The plants utilize carbon dioxide at a variable rate, depending upon the species of plant, the growth rate, the nutrient levels of the soil or other growing medium, and where in the plant life cycle the plant(s) is (are).

Control system 1210 controls components of system 1100 to maintain a desirable level of carbon dioxide in environment 1202. A desirable level of carbon dioxide in the plant growing environment 1202 is determined based on the plant(s) type(s), plant(s) development stage(s) and other factors. Control system 1210 consists of one or more carbon dioxide monitors within plant environment 1202. These carbon dioxide monitor(s) are connected through control system 1210 to the vents 1107 in conduit 1106 connecting the mushroom environment 1102 to plant environment 1202. When the carbon dioxide levels drop below the preset levels determine by control system 1210, a signal is sent to vent 1107-5, closing vent 1107-5 to atmosphere or other external area. Once vent 1107-5 is closed, the carbon dioxide from mushroom environment 1102 is now directed and delivered to plant environment 1202 rather than being exhausted elsewhere. As the mushroom-generated carbon dioxide enters plant environment 1202, the carbon dioxide levels rise. When the carbon dioxide rises to a threshold level (e.g., set by the control system 1210 based on combinations of conditions favorable to growth rates of plants 1203), control system 1210 sends a signal to vent 1107-5, opening vent 1107-5, and once again dumping the mushroom carbon dioxide externally. As plants 1203 consume the carbon dioxide, the level drops, at which point the aforementioned cycle repeats and maintains the carbon dioxide in the plant environment 1203 at a desired level or within a desirable range.

In this manner the optimum ratios of oxygen and carbon dioxide are maintained in both the mushroom growing environment and the plant growing environment.

The described growing processes, procedures, technologies and systems are scalable from mini to mega farms. FIG. 4 shows two specific growing environments, a mushroom growing environment 1102 and a plant growing environment 1202. In one embodiment, there would be series of environments/rooms 1102 and 1202 operating in balance. For example, a mega farm could have a large number mushroom growing rooms 1102 that would produce massive amounts of carbon dioxide, that can be distributed to series of rooms 1202 that are growing various fruits, vegetables, and/or other plants. In some examples, the carbon dioxide from mushroom growing environment(s) 1102 can be stored in vessels and these vessels are used as conduits to transfer the carbon dioxide from environment 1102 to environment 1202.

Each plant growing room 1202 can be configured specifically for the plants 1203 within the room. For example, the plants can grow in substrate selected for the specific plant, light color and sequencing, temperature sequencing, watering and humidity control also all selected for the specific plant. Additionally, the carbon dioxide level in the environment is controlled to the targeted parts per million (PPM) for that specific plant based on other conditions and based on the stage in the plants' development.

These conditions are recorded and monitored 24/7 and can be monitored and controlled with a computing device, for example, a smart phone.

The physical size of these environments can vary in size. In one example, mushroom environment 1202 is 20′×10′×10′. The number of mushroom environments 1202 can be calculated by first determining the targeted plant yields. Plant growing rooms 1202 can be much larger. The environment sizing process begins by identifying the desired crops, and the annual targeted yields. Regardless of the size, the symbiotic environments are operated using a process where the crops are available 12 months a year.

FIG. 4 shows one example mushroom growing room 1102 and one vegetable, fruit or flowering plant growing room 1202. In other examples, this system can include large laboratories, seedling operations, aquaponics and hundreds of clean rooms generating metric tons of fruits and vegetables.

As shown, there are a number of actuatable vents 1107-1, 1107-2, 1107-3, 1107-4 (collectively referred to as vents 1107). These vents 1107 can vary the amount of air that passes through a given area. In some examples, vents 1107 can open completely such that substantially no resistance is enacted on the passing air. In some examples, vents 1107 can completely close that substantially no air passes through vent 1107. In some examples, vents 1107 can vary the air flow through vent 1107 at a variable rate.

Vents 1107 can include those manufactured by Tecomak, Environmental Simple, and Terra Universal. In some examples, environments 1102, 1202 integrate various scientific technologies, from the designs of critical high tolerance HVAC system, clean room design with micro control systems.

As shown, the inlet 1105 of conduit 1106 is located proximate the ground of environment 1202. This allows a disproportionate amount of carbon dioxide (relative to the concentrations in the rest of the room) to be drawn into conduit 1106 when the pressure in environment 1102 is higher than environment 1202 or externally. This is because carbon dioxide gas is heavier that air will tend to settle to lowest portions of a given volume.

The mushroom operation 1102 produces the designed quantities of carbon dioxide to be utilized to create the best growing conditions for the targeted plant 1203. The mushrooms 1103 are cultivated within desired growing conditions, which produce volumes of high-grade edible mushroom, for example, Oyster and Shiitake mushrooms. The process of successfully pairing mushroom cultivation with plant cultivation is complex. The sciences that converge include mycology, botany, agronomy, and clean room design and operation.

Controlling the various technical functions requires precision sensing, monitoring, recording, and communications systems. Some example devices used for the Growing Room Control System, are produced by RKI, carbon dioxideMETER.com, and Techmark-Inc.

Although the subject matter has been described in language specific to structural features or methodological acts, it is to be understood that the subject matter defined in the appended claims is not necessarily limited to the specific features or acts described above. Rather, the specific features and acts described above are disclosed as example forms of the claims.

What is claimed is:

1. A symbiotic agricultural system comprising:
a fungi growing environment;
a plant growing environment; and
a control system that controls airflow from the fungi growing environment to the plant growing environment based on a carbon dioxide level in the plant growing environment.

2. The symbiotic agricultural system of claim 1, further comprising a carbon dioxide sensor configured to sense the carbon dioxide level in the plant growing environment.

3. The symbiotic agricultural system of claim 2, further comprising a conduit connecting the fungi growing environment and the plant growing environment, the conduit configured to facilitate the airflow.

4. The symbiotic agricultural system of claim 3, wherein the conduit comprises a storage vessel.

5. The symbiotic agricultural system of claim 3, wherein the conduit comprises a duct.

6. The symbiotic agricultural system of claim 5, further comprising a vent coupled to the duct, the vent being actuatable between an open position where airflow is substantially unrestricted and a closed position where airflow is substantially blocked.

7. The symbiotic agricultural system of claim 6, wherein the vent is actuatable to positions between the open position and the closed position.

8. The symbiotic agricultural system of claim 7, wherein the control system controls the airflow from the fungi growing environment to the plant growing environment, at least in part, by sending signals to the vent to actuate between a first position and a second position.

9. The symbiotic agricultural system of claim 6, wherein an inlet of the conduit is located in a volumetric bottom half of the fungi environment.

10. The symbiotic agricultural system of claim 9, wherein the control system controls pressurization of the fungi growing based at least in part on the carbon dioxide level in the plant growing environment.

11. The symbiotic agricultural system of claim 10, further comprising a fan configured to pressurize the fungi growing environment.

12. The symbiotic agricultural system of claim 10, wherein the control system controls the fan based, at least in part, on the carbon dioxide level in the plant growing room.

13. The symbiotic agricultural system of claim 1, further comprising an outlet valve fluidically coupling the fungi growing environment to an exterior environment, wherein the control system controls the outlet valve based, at least in part, on the carbon dioxide level in the plant growing room.

14. A symbiotic agricultural system comprising:
a fungi growing environment;
a plant growing environment fluidically coupled to the fungi growing environment;
a control system configured to control a transfer of carbon dioxide from the fungi growing environment to the plant growing environment.

15. The symbiotic agricultural system of claim 14, wherein the fungi growing environment is pressurized above the plant growing environment such that air in fungi growing environment is biased towards plant growing environment.

16. The symbiotic agricultural system of claim 14, wherein the plant growing environment comprises a vertical farming system.

17. The symbiotic agricultural system of claim 14, wherein the fungi growing environment comprises one or more of: oyster or shiitake mushrooms.

18. A method of operating an agricultural system, the method comprising:
sensing, at least periodically, a carbon dioxide level in a plant environment; and
controlling flow of air from a fungi environment to the plant environment until the sensed carbon dioxide level reaches a threshold level.

19. The method of claim 18, wherein controlling flow of air from the fungi environment to the plant environment comprises:
pressurizing the fungi environment to a pressure above the plant environment.

20. The method of claim 19, wherein controlling flow of air from the fungi environment to the plant environment comprises:
actuating a valve that fluidically couples the fungi environment to an external environment in a way that decreases airflow from the fungi environment to the external environment.
